(19) United States
(12) Patent Application Publication
(10) Pub. No.: US 2002/0172458 A1
(43) Pub. Date: Nov. 21, 2002

(54) Optical system that improves spectrally distorted signals

(76) Inventor: John D. Downie, Painted Post, NY (US)

Correspondence Address: Price, Heneveld, Cooper, Dewitt, & Litton, ATTN: Michael R. Long, 695 Kenmoor S.E., Grand Rapids, MI, 49501, US

(21) Appl. No.: 09/896,089

(22) Filed: Jun. 29, 2001

Related U.S. Application Data
(60) Provisional application No. 60/281,980, filed on Apr. 6, 2001.

(51) Int. Cl. G02B 6/26; G02B 6/28

(52) U.S. Cl. 385/31; 385/27; 385/24

(57) ABSTRACT

An optical system that maximizes signal quality related to spectral shape of an optical signal includes a light source module, a light receiver module, a plurality of fixed optical filters and a tunable optical filter. The light source module includes a light source that provides an optical signal to an optical fiber that includes a plurality of optical fiber segments. The light receiver module includes a receiver input that receives the optical signal from one of the plurality of the optical fiber segments. The plurality of fixed optical filters filter the optical signal and are coupled between the light source module and the light receiver module by the plurality of optical fiber segments. The tunable optical filter includes a control input, a filter input and a filter output. The filter input receives the optical signal and the filter output provides a filtered optical signal. A center filter frequency of the tunable optical filter is varied to maximize signal quality exhibited by the filtered optical signal responsive to a control signal on the control input.

This application claims priority based on U.S. Provisional Patent Application Serial No. 60/281,980 (Docket No. SP01-083P) entitled, “DEVICES AND METHODS FOR OPTICAL FILTERING TO IMPROVE SIGNAL QUALITY,” by John D. Downie, filed Apr. 6, 2001, the disclosure of which is hereby incorporated by reference.

### BACKGROUND OF THE INVENTION

1. Field of the Invention

The present invention is generally directed to an optical system and, more specifically, to an optical system that improves spectrally distorted signals.

2. Technical Background

Today, optical systems, such as wavelength division multiplexed (WDM) systems, have become more optically transparent, which has allowed signals to remain in the optical domain for longer distances. In a typical optical system, an optical signal may pass through many cross-connects and/or add/drop multiplexers when traveling from a transmitter to a receiver. These cross-connects and add/drop multiplexers have typically included wavelength selective optical filters, which have been utilized to multiplex and demultiplex desired optical signals. Unfortunately, when an optical signal travels through an optical system with various wavelength selective components, e.g., optical filters, the optical signal may experience time-domain distortion when the signal spectrum is non-uniformly attenuated by a composite filter function, produced by a concatenation of individual optical filters.

Tunable optical filters have been widely used to block light components other than a desired optical signal, such as spontaneous emission from an optical amplifier, to improve transmission characteristics of the desired optical signal and enhance long distance transmission. For example, in one optical system, an emission wavelength of a tunable light source and a wavelength transmission characteristic of a tunable optical filter were adjusted to achieve the optimum transmission characteristic for the system. In this system, the transmission characteristic of the optical signal was measured at an optical detector to determine the emission wavelength that maximized the transmission characteristics of the system. Control information was then sent to a drive circuit of the light source to control the wavelength of the light source, while simultaneously applying the control information to a tunable optical filter to align the center wavelength of the filter with the emission wavelength of the light source.

Various optical systems have implemented transmission characteristic measuring sections constructed to measure a bit-error rate (BER), an eye diagram or a Q-factor associated with an optical signal. In measuring sections that have used an eye diagram, when the eye diagram opened to its widest point, the transmission characteristics of the optical system were optimal. In measuring sections that have measured the Q-factor of a received signal, the Q-factor of a signal has typically been defined as follows:

Q=10log₁₀[(μ₁−μ₀)/(σ₁+σ₀)]

where μ₁ is the average level during emission, μ₀ is the average level during no emission, σ₁ is the standard deviation of average level during emission, and σ₀ is the standard deviation of the average level during no emission. When a Gaussian noise distribution is assumed, the bit-error rate corresponding to the Q-factor, defined by the above equation, generally agrees with the minimum value of the actually measured bit-error rate. A typical Q-factor measuring system has generally used a discrimination circuit having a reference voltage varying function. The discrimination level of the equalizing waveform has typically been varied up and down with respect to the optimum level to measure the bit-error rate (BER), and by finding the intersection of the two straight lines obtained from the measurement, the minimum point of the BER has been estimated to obtain the Q-factor.

Q-factor monitoring has been performed using a number of techniques and has been performed at or implemented within a receiver. A typical Q-factor monitor has included two decision circuits, one of which has a fixed threshold level (for detecting the actual data) and another, which has a variable threshold level (that is used to estimate the signal Q-factor or BER). While various optical systems have included tunable filters, these systems have not generally minimized time-domain distortions in an optical signal or increased the extinction ratio of the optical signal.

Thus, what is needed is an optical system that generally improves the signal quality of optical signals with time-domain distortions or optical spectrum related impairments.

### SUMMARY OF THE INVENTION

An embodiment of the present invention is directed to an optical system that maximizes signal quality related to spectral shape of an optical signal. The optical system includes a light source module, a light receiver module, a plurality of fixed optical filters and a tunable optical filter. The light source module includes a light source that provides an optical signal to an optical fiber that includes a plurality of optical fiber segments. The light receiver module includes a receiver input that receives the optical signal from one of the plurality of the optical fiber segments. The plurality of fixed optical filters filter the optical signal and are coupled between the light source module and the light receiver module by the plurality of optical fiber segments. The tunable optical filter includes a control input, a filter input and a filter output. The filter input receives the optical signal and the filter output provides a filtered optical signal. A center filter frequency of the tunable optical filter is varied to maximize signal quality exhibited by the filtered optical signal responsive to a control signal on the control input.

Additional features and advantages of the invention will be set forth in the detailed description which follows and will be apparent to those skilled in the art from the description or recognized by practicing the invention as described in the description which follows together with the claims and appended drawings.

It is to be understood that the foregoing description is exemplary of the invention only and is intended to provide an overview for the understanding of the nature and character of the invention as it is defined by the claims. The accompanying drawings are included to provide a further understanding of the invention and are incorporated and constitute part of this specification. The drawings illustrate various features and embodiments of the invention which, together with their description serve to explain the principals and operation of the invention.

### BRIEF DESCRIPTION OF THE DRAWINGS

FIG. 1A is a block diagram of an exemplary optical system, according to an embodiment of the present invention;

FIG. 1B is a block diagram of a light receiver module, according to one embodiment of the present invention;

FIG. 1C is a block diagram of a light receiver module, according to another embodiment of the present invention;

FIGS. 2-3 are eye diagrams of an optical signal before and after compensation, respectively, according to an embodiment of the present invention;

FIGS. 4-5 are eye diagrams of an optical signal before and after compensation, respectively, according to another embodiment of the present invention;

FIG. 6 is a graph depicting a passband of an optical filter and a signal spectrum of a directly modulated laser (DML) that is misaligned with the center frequency of the optical filter;

FIG. 7 is a graph of four signal curves depicting the relationship between total eye closure penalty (ECP) as a function of laser/filter offset for 2, 6, 14, and 30 optical filters;

FIG. 8 is a graph depicting the optical spectrum of a 10 Gbit/s directly modulated distributed feedback (DFB) laser in an unfiltered and optimally filtered through a fourteen filter path;

FIG. 9 is a graph depicting a total eye closure penalty (ECP) as a function of laser/filter frequency offset for 32 GHz and 64 GHz half-power bandwidth optical filters;

FIG. 10 is a block diagram of a tunable optical filter that is integrated with a DML, according to an embodiment of the present invention;

FIG. 11A is a graph depicting a power waveform for an adiabatic chirp dominated DML;

FIG. 11B is a graph depicting a chirp waveform for the DML of FIG. 11A;

FIG. 11C is a power waveform of a transient chirp dominated DML;

FIG. 11D is a chirp waveform of the transient chirp dominated DML of FIG. 11C;

FIG. 12A depicts the optical spectra of an OC-48 DML (2.5 Gbit/s) with adiabatic chirp;

FIG. 12B depicts the optical spectra of an OC-48 DML (2.5 Gbit/s) with transient chirp;

FIG. 13A depicts the optical spectra of an OC-192 DML (10 Gbit/s) with adiabatic chirp;

FIG. 13B depicts the optical spectra of an OC-192 DML (10 Gbit/s) with transient and adiabatic chirp;

FIG. 14 is a graph depicting the transmission spectrum of a multilayer interference filter and a third-order Butterworth filter transfer function;

FIG. 15 is a typical eye diagram showing the maximum eye opening position with a time window defined around it as well as a minimum one and a maximum zero within the window;

FIG. 16 is a graph depicting waveforms that illustrate the distortion induced ECP as a function of the number of filters traversed, for an OC-48 DML (2.5 Gbit/s) with adiabatic chirp;

FIG. 17A is a graph depicting distortion induced ECP as a function of the laser offset;

FIG. 17B is a graph of a waveform depicting the excess loss as a function of the laser offset;

FIG. 18 is a graph showing two waveforms depicting the distortion induced ECP as a function of the number of filters traversed for an OC-48 DML (2.5 Gbit/s) with transient chirp for laser offsets of −40 GHz and +35 GHz;

FIG. 19A depicts a graph illustrating a waveform that shows the distortion induced ECP as a function of laser offset for an OC-48 DML (2.5 Gbit/s) with transient chirp;

FIG. 19B is a graph depicting the excess loss as a function of the laser offset for an OC-48 DML (2.5 Gbit/s) with transient chirp;

FIG. 20 is a graph depicting the distortion induced ECP as a function of the number of filters for laser offsets of 0 GHz, −5 GHz and −40 GHz;

FIG. 21A is a graph depicting a waveform of distortion induced ECP as a function of the laser offset for an OC-192 DML (10 Gbit/s) with adiabatic chirp;

FIG. 21B is a graph depicting the excess loss as a function of the laser offset for an OC-192 DML (10 Gbit/s) with adiabatic chirp;

FIG. 22 is a graph depicting the distortion induced ECP graphed as a function of the number of filters for laser offsets of +15 GHz, +10 GHz and -40 GHz for an OC-192 DML (10 Gbit/s) with transient and adiabatic chirp;

FIG. 23A is a graph depicting the distortion induced ECP as a function of the laser offset for an OC-192 DML (10 Gbit/s) with transient and adiabatic chirp; and

FIG. 23B is a graph depicting the excess loss as a function of the laser offset for an OC-192 DML (10 Gbit/s) with transient and adiabatic chirp.

### DETAILED DESCRIPTION OF THE PREFERRED EMBODIMENTS

According to one embodiment of the present invention, a tunable optical filter is implemented in an optical system adjacent to or within a light receiver module and/or adjacent to or within a light source module. According to another embodiment, the center frequency of optical filters located within a plurality of multiplexer/demultiplexer modules is offset from a center frequency of the light source (e.g., a direct modulated laser) distributed throughout the optical system. By appropriately adjusting the center frequency of the tunable optical filter and/or the center frequency of the light source, the signal quality of a received optical signal, which exhibits time-domain distortion due to passage through multiple optical filters or due to poor transmitter modulation quality, can generally be improved. The tunable optical filter may be a tunable Fabry-Perot filter, a tunable Bragg grating filter (in a fiber or a waveguide) or another tunable spectral filter. According to the present invention, the center frequency of the tunable optical filter is adjusted to minimize the amount of time-domain distortion exhibited by the optical signal or maximize the signal quality. When a tunable optical filter is implemented at a receiver, a bit-error rate (BER) or a Q-factor of the optical signal is monitored and the tunable optical filter is adjusted accordingly. When a tunable optical filter is implemented at a light source, a wavelength of the light source is monitored and the center wavelength of the tunable optical filter is adjusted to maintain an optimum offset from the center frequency of the light source as its center frequency varies. It should be appreciated that a monitor at the receiver need not accurately measure the BER or the Q-factor of the optical signal, providing the monitor can track the relative change in Q-factor or BER as the tunable optical filter is tuned.

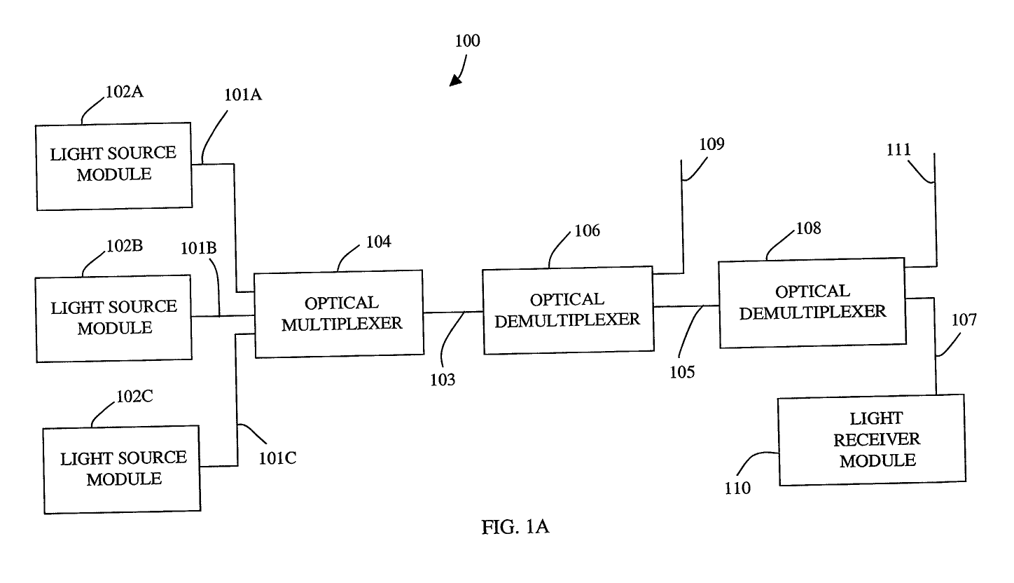

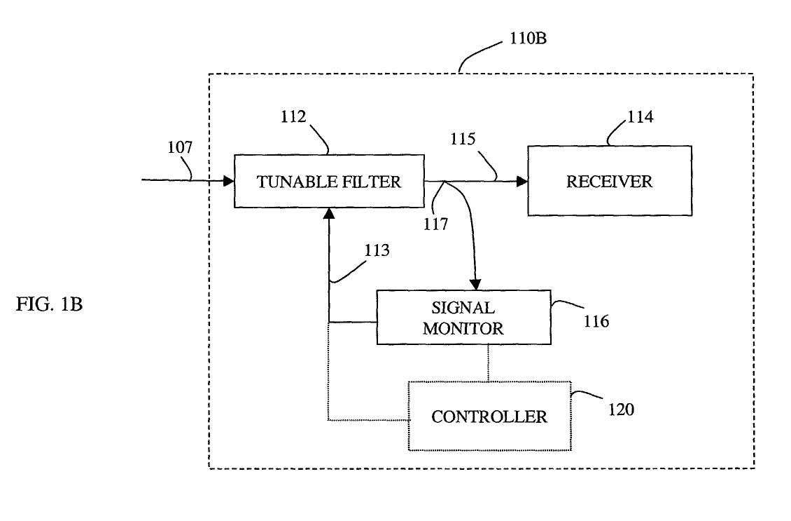

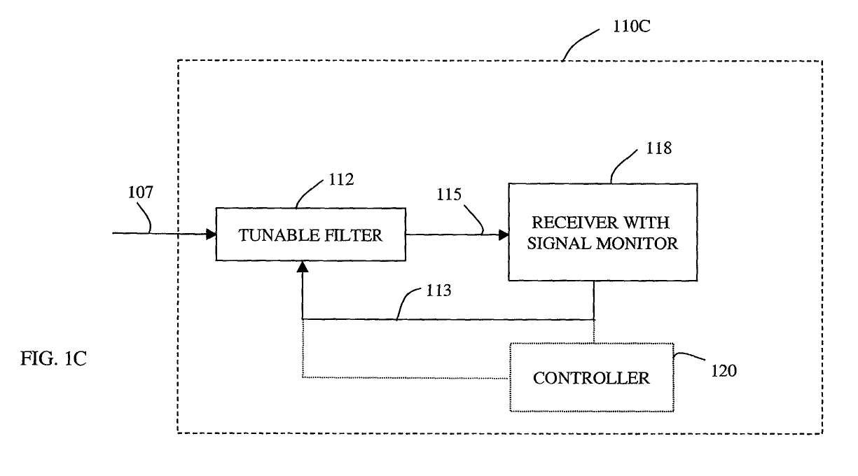

An exemplary optical system 100 is depicted in FIG. 1A. As shown, the optical system 100 includes a plurality of light source modules 102A, 102B and 102C that are coupled to an optical multiplexer 104, which includes optical filters, via optical fibers 101A, 101B and 101C, respectively. The multiplexer 104 functions to perform wavelength division multiplexing (WDM) on the optical signals, carried on the fibers 101A, 101B and 101C, and provides those signals to an optical fiber 103. The multiplexer 104 is coupled to an optical demultiplexer 106, which includes optical filters, via the fiber 103. The demultiplexer 106 serves to drop, for example, the optical signal that was originally provided by the light source module 102B and provide that signal to an optical fiber 109. As shown, the demultiplexer 106 is also coupled to another optical demultiplexer 108, via an optical fiber 105. In general, there is a multiplexer corresponding to each demultiplexer, i.e., a demultiplexer for each multiplexer (not shown in 1A). The optical demultiplexer 108 also includes optical filters that serve to demultiplex the optical signals provided by the light source modules 102A and 102C. The optical demultiplexer 108 separates the optical signals and provides the optical signal provided by the light source module 102C to optical fiber 111. The demultiplexer 108 provides the optical signal provided by the light source 102A to a light receiver module 110, via an optical fiber 107.

As shown in FIG. 1B, an optical signal, provided on the optical fiber 107, is coupled to a tunable optical filter 112, located within a light receiver module 110B. The tunable optical filter 112 is coupled to the receiver 114, via an optical fiber 115, and to a signal quality monitor 116, via a tap 117. An output of the monitor 116 is coupled, via a control line 113, to a control input of the filter 112. In this manner, the output of the monitor 116 is utilized to vary the center frequency of the tunable optical filter 112 to improve the quality of the received optical signal. Alternatively, the output of the monitor 116 can be routed to a controller 120 that is programmed to provide an appropriate output, responsive to the output from the monitor 116, to the tunable optical filter 112 on the control line 113. FIG. 1C depicts another light receiver module 110C. that includes a receiver 118 that incorporates a signal quality monitor. In this embodiment, the monitor provides the control signal on the control line 113. It should be appreciated that the receiver 118 can also directly provide an output to a controller 120, which, responsive to the output, is programmed to provide an output on the control line 113.

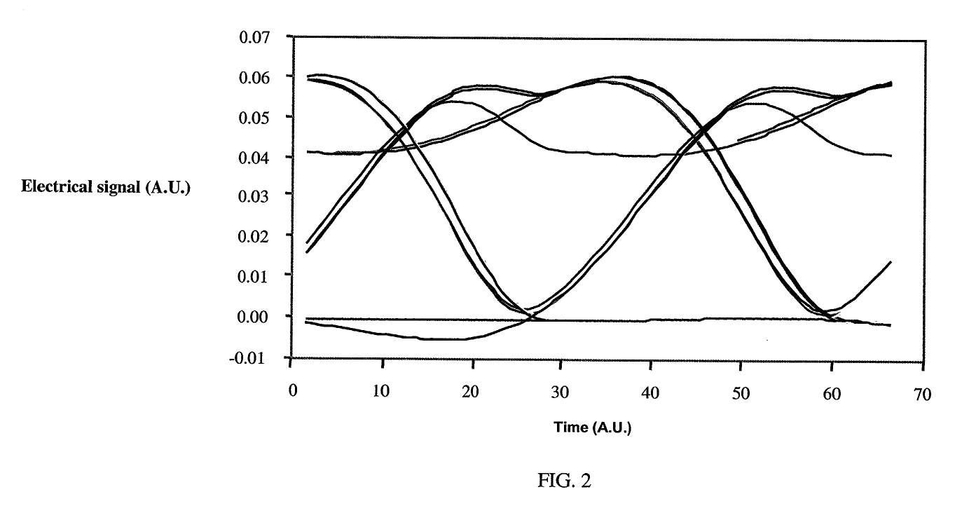

FIG. 2 shows an exemplary eye diagram of a 10 Gbit/s externally modulated source (e.g., a DML) signal that has been distorted by passage through a concatenated set of optical filters that are offset from the center frequency of the source signal. That is, the signal spectrum has been asymmetrically clipped by the filters, which leads to distortion in the time-domain and a degraded eye diagram. The normalized eye closure (NEC), which is defined as the average ones value divided by the difference of the minimum ones value and the maximum zeros value, of the signal shown in FIG. 2 is about 1.7 dB, excluding amplifier noise.

FIG. 3 shows an eye diagram of the same optical signal after passing through a tunable Fabry-Perot filter, with a finesse value of 350. The transmission function of the Fabry-Perot filter is centered on the nominal center wavelength of the light source. As shown in FIG. 3, the optical signal after passage through the Fabry-Perot filter is more open than it was prior to passing through the filter, as shown in FIG. 2. The approximate NEC value of the optical signal of FIG. 3 is about 0.7 dB, which represents an improvement in the NEC of about 1.0 dB in comparison to the optical signal of FIG. 2. In general, an improvement in the NEC leads to roughly the same amount of improvement in the Q-factor of the signal and thus generally reduces the BER of the optical signal. However, the average power of the optical signal of FIG. 3 has also decreased by about 0.45 dB after passage through the Fabry-Perot filter, which tends to offset the improvement in the quality of the optical signal. As such, any increase in signal quality due to a reduction of distortion is somewhat offset by the insertion loss attributable to the tunable optical filter. Thus, it is desirable to minimize the insertion loss of the tunable optical filter to minimize the attenuation of the optical signal. Further, the tunable optical filter should generally be designed to minimize degradation of high quality signals.

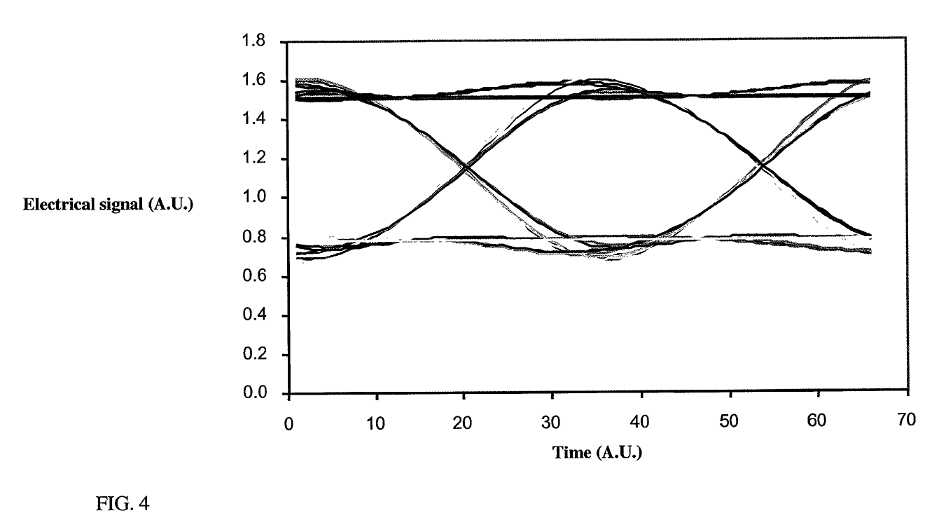

The chirp of a directly modulated laser can also induce spectral distortion into an optical signal. In particular, lasers with adiabatically dominated chirp (see FIG. 6) have two peaks within their spectrum corresponding to the frequency of the zeros and the ones. In such a case, a tunable optical filter, adjacent to the receiver or transmitter, can also normally be used to further attenuate the zeros frequency and actually improve the eye opening from its unfiltered state.

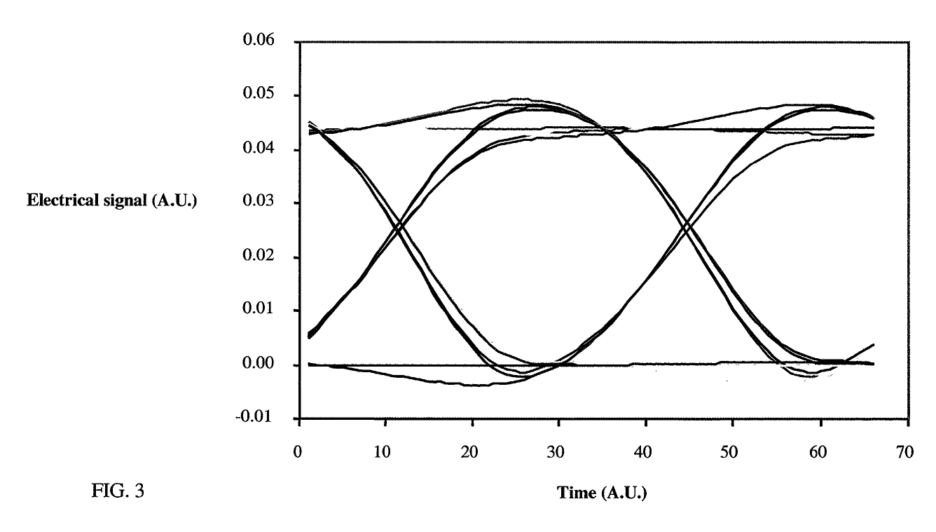

FIG. 4 depicts an eye diagram of another 10 Gbit/s unfiltered optical signal. FIG. 5 depicts the signal of FIG. 4 after it has been filtered through a Fabry-Perot filter with a finesse value of 350. The Fabry-Perot filter is offset from the nominal center frequency of the signal by about 20 GHz. By examining the values on the ordinates in FIGS. 4 and 5, it can be seen that the filtered signal has an improved extinction ratio, which generally leads to an improvement in the NEC (in this case by approximately 2.0 dB).

A center frequency of a laser transmitter in a WDM optical system is typically aligned with the center of the transmission passband of the multiplexing and demultiplexing filters of the system. This is done so as to pass all frequencies within a signal spectrum equally and therefore not change the signal spectrum. However, for some types of directly modulated lasers (DMLs) with adiabatically dominated chirp characteristics, it can be advantageous to intentionally misalign the nominal laser center frequency and the center frequency of the system filter(s). In this way, one can purposefully attenuate the part of the signal spectrum associated with the “zeros” bits (where there is power because of a finite extinction ratio), and thus increase the extinction ratio and signal Q-factor. Furthermore, through computer simulations, it is generally possible to estimate the optimal amount of frequency offset for a given number of filters with a given filter shape.

With the correct frequency misalignment, the filters preferentially attenuate the signal spectrum frequencies corresponding to the “zeros” bits while the “ones” bits remain relatively unaffected. In this manner, the network designer can use laser/filter misalignment to optimize the signal quality and the optimal misalignment can be estimated with knowledge of the laser spectrum, the transmission shape of the filters and the number of filters that the signal passes through from transmitter to receiver. FIG. 6 is an exemplary graph depicting a 10 Gbit/s directly modulated laser spectrum that is intentionally offset from the center frequency of a WDM filter passband.

The primary manner in which signal quality from a directly modulated distributed feedback (DFB) laser is improved as a result of intentional offset between the laser center frequency and the filter center frequency is through an increase in the extinction ratio, which is the ratio of the signal power of the “ones” to the signal power of the “zeros.” For some adiabatically chirped DMLs, the extinction ratio of the signal provided by the laser is quite poor. In such cases, the lasers may be used only for fairly short point-to-point links, or not used at all because of their poor performance. Improvement of the extinction ratio may generally allow network designers to use lower cost DMLs over longer distances and through several optical network elements, providing transparent network architectures at a lower cost.

In the discussion that follows, a light source is modeled as a directly modulated DFB laser operating at 10 Gbit/s. Further, the add/drop multiplexing filters are modeled as third-order Butterworth filters. The third-order Butterworth filter approximately represents a thin film multi-layer interference filter. In the following discussion, the signal quality is assessed by evaluating the total eye closure penalty (ECP). The eye opening is defined as the difference between the minimum “ones” value and the maximum “zeros” value in the eye diagram of a signal, or

eye=I_{1,min}−I_{0,max}.

The total ECP is defined as the ratio of the eye opening in the absence of filters to the eye opening after passage through a given number of filters, and expressed in dB units:

total eye closure penalty (dB)=10log[eye(no filters)]−10log[eye(through N filters)]

This definition of the total ECP takes into account both an increase in the extinction ratio (a negative change) and any excess loss (a positive change). It should be noted that a negative penalty indicates that the signal quality has actually improved after passage through a set of filters, in comparison to the original unfiltered signal.

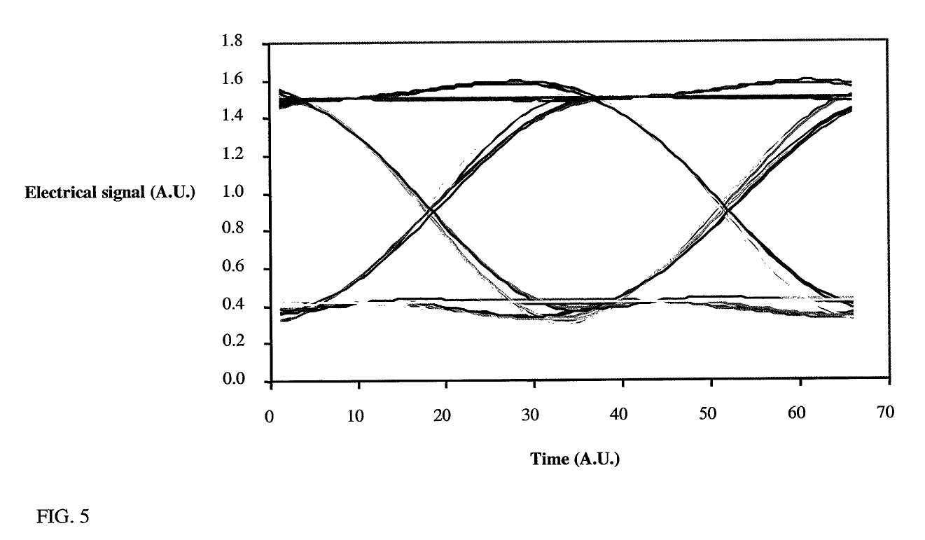

FIG. 7 shows a graph whose response curves illustrate that the optimal frequency offset between the laser nominal center frequency and the center frequency of a WDM filter varies according to the number of filters in the path of the signal. The modeled filters have a −3 dB (half-power) bandwidth of 32 GHz, which is appropriate for a channel spacing of 100 GHz. As shown, the optimal laser/filter offset is greater than 40 GHz for a path with only two filters, but is about 30 GHz for a path with thirty filters. The reason for this is that the effective overall filter function is significantly narrower for a greater number of filters traversed, meaning that the laser center frequency offset can be smaller and still achieve the desired effect of preferentially attenuating the “zeros” part of the spectrum. In FIG. 7, all filters are aligned with each other. A misalignment tolerance of the center frequency of a filter may shift the results somewhat, but should not alter the conclusion that the optimal laser/filter offset is dependent on the number of filters.

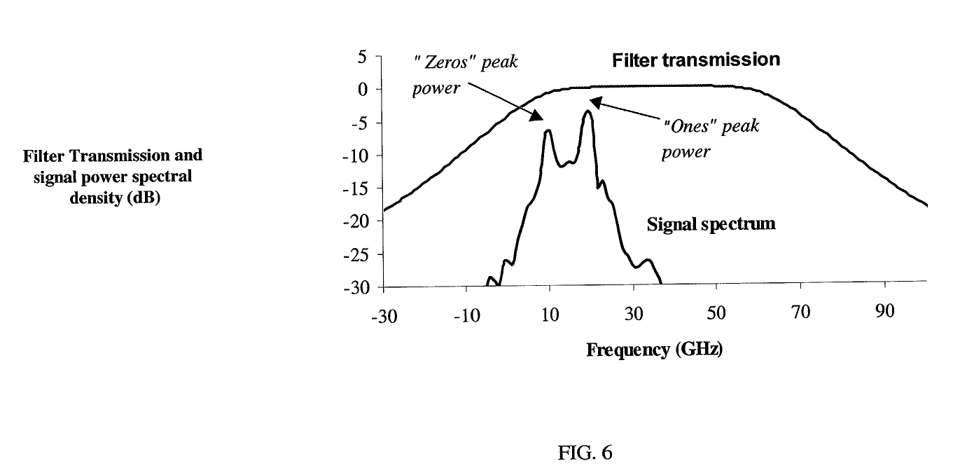

FIG. 8 shows a signal spectrum of a 10 Gbit/s laser as it leaves the laser (unfiltered) and after passing through fourteen filters with optimal offset. As depicted in FIG. 7, the optimal offset for fourteen filters is about −35 GHz. As shown in FIG. 8, the filtering effect attenuates the “zeros” spectral peak by approximately 12 to 13 dB, while leaving the “ones” spectral peak practically undiminished. The overall effect is to produce a total ECP of about −2.5 dB, which leads to a Q-factor “penalty” of about the same amount. This produces a signal with a much lower bit-error rate (BER) than would be obtained directly from the laser.

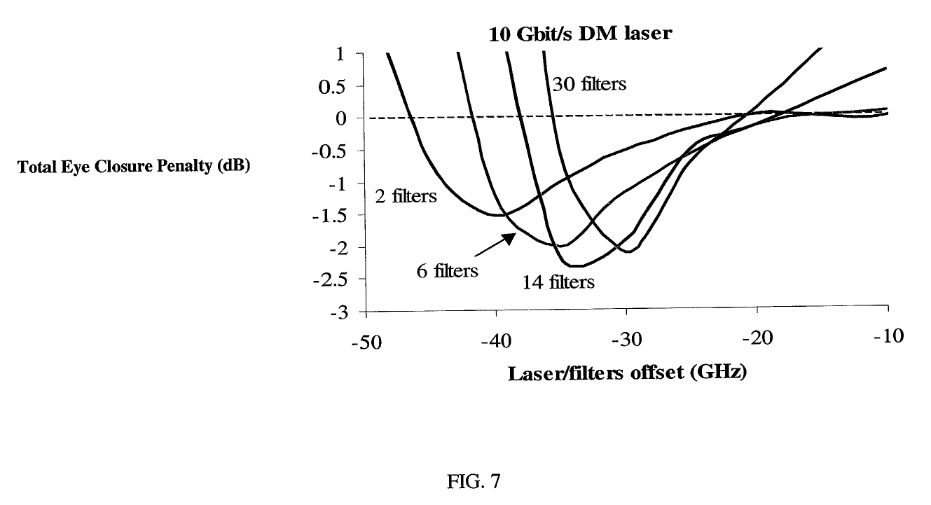

FIG. 9 illustrates that the optimal laser/filter frequency offset is not only a function of the number of filters, but also the relative width of the filters. The graph results, shown in FIG. 9, are for a fourteen filter path with one data set corresponding to a 32 GHz filter and the other corresponding to a 64 GHz filter. We note that ITU has standards for the acceptable range of laser center frequency offset from the ITU frequency grid. For example, the acceptable range around each ITU grid frequency is +40 GHz for a 200 GHz channel spacing system. However, it may be that the optimal laser/filter offset for a given system is greater than the ITU standards allowed for laser offset. In this case, the network designer can apply suitable offsets to both laser and filters (in opposite directions about the ITU grid point) to achieve a desired optimal misalignment. As noted above, a tunable optical filter may also be integrated with a laser transmitter to improve the signal quality of some directly modulated lasers with adiabatic chirp characteristics and poor extinction ratios.

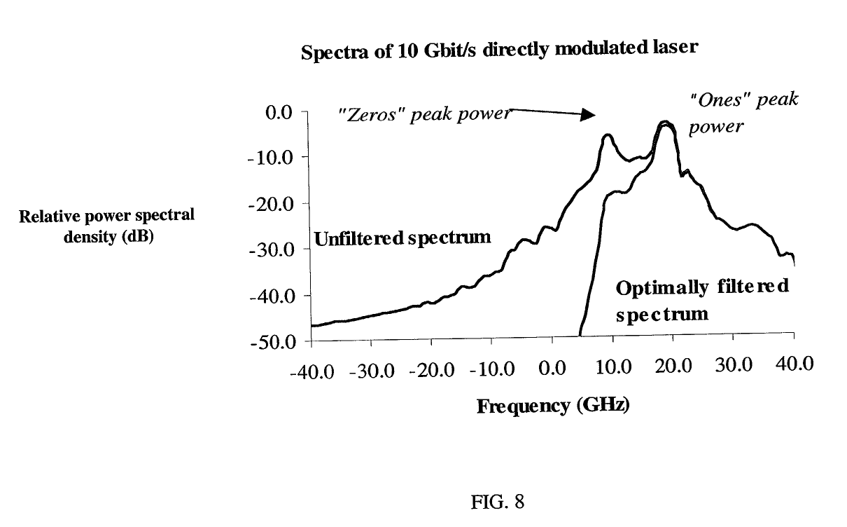

FIG. 10 illustrates an exemplary light source module 102A in which a tunable optical filter 112 is integrated with the DML 1002. While there is generally a fixed optimal alignment between the laser 1002 spectrum and the filter 112, the filter 112 center frequency may have to change with time if the laser 1002 center frequency shifts with time. In this case, the laser 1002 center frequency is monitored and the frequency position is fed back to the filter 112 in a closed loop.

A primary application of the technique described herein is to improve the quality of adiabatically chirped DMLs with relatively poor extinction ratio. In this case, the filtering effect reduces the optical spectrum associated with the “zeros” bits, thereby increasing the extinction ratio of the signal. As previously mentioned, such filtering may be done by passing through a tunable optical filter such as a tunable Fabry-Perot filter either at the transmitter or at the receiver. If done at the transmitter, the filter alignment can be controlled by a wavelength monitor 1004 to keep it at a certain fixed alignment relative to the laser wavelength.

As previously discussed, a potentially serious signal impairment that is unique to optically transparent networks in comparison to opaque networks is the effect of transmission through multiple optical WDM filters. Potentially degrading effects of cascades of individual optical filters include spectral clipping of the signal spectrum and/or enhanced chromatic dispersion due to non-linear filter phase functions. The effects can be pronounced if the laser center frequency drifts away from the center position of the overall filter passband, and toward the edges of the filter passband. The effects of filter concatenation are generally not a concern in a point-to-point optical system, as a given signal passes through at most two filters, e.g., a multiplexer and a demultiplexer. However, in transparent optical networks, a signal may be multiplexed and demultiplexed at many optical cross-connect or optical add/drop elements throughout its path before it is finally received. Thus, the signal experiences the concatenation of the entire set of filters in its path. The effective spectral transfer function of the cascaded filter set is the multiplication of each of the individual filters, which can therefore be much narrower in spectral width than a single filter. Spectral narrowing of the effective transfer function can be further accelerated by any misalignments in center frequency of the individual filters traversed by the signal. If the transmission laser is offset from the center of the passband of the effective filter transfer function, then part of the signal spectrum may be attenuated out of proportion to the rest of the spectrum as the signal gets too close to one of the sidewalls of the filter transfer function. This in turn can lead to a time-domain distortion and a distortion induced normalized ECP in addition to simple excess signal loss.

In the following discussion, the reference network architecture is an optically transparent metropolitan size optical network. Within this framework, the WDM filters that might be traversed by an optical signal are limited to a maximum of twenty. A filter count of twenty represents a multiplexer at the source, a demultiplexer at the receiver, and passage through up to nine optical network elements, where the signals are multiplexed and demultiplexed in between.

In cost-sensitive metropolitan area networks, the use of directly modulated distributed feedback (DFB) lasers as transmitters is attractive. The characteristics of such networks, in terms of transmission distance (typically 80 km-300 km) and bit rate (typically 2.5 Gb/s), are typically not overly demanding and therefore, the performance requirements on optical devices are somewhat relaxed in comparison to long distance networks. However, DMLs often exhibit the unwanted characteristic of frequency chirp, in which the instantaneous optical frequency varies with time over the duration of the individual bit pulses. Frequency chirp, in general, acts to broaden the spectrum of the signal and it can impose system limitations with regard to the maximum transmission distance due to the fiber dispersion and the maximum number of filters that such a signal can traverse. While the dispersion-induced limitations of directly modulated lasers can be overcome by using dispersion compensation or negative dispersion fibers, the limitations induced by spectral filtering cannot be easily compensated and the effects of filter concatenation are therefore an important consideration in the design of transparent optical networks.

In the discussion that follows, several different directly modulated DFB lasers are compared with respect to signal degradation from filter concatenation. Such lasers often have very different frequency chirp characteristics that can lead to significantly different optical spectra. Therefore, various DMLs may experience distinctly different signal impairments upon passage through a set of WDM filters in an optical network, and require different frequency stability conditions for acceptable performance. It is noted that DMLs with transient dominated chirp characteristics exhibit generally symmetric behavior with respect to laser center frequency drift around the nominal center frequency. On the other hand, it is noted that DMLs with adiabatic dominated chirp features generally have a highly asymmetric response to laser frequency drift. Thus, the performance of DMLs with adiabatic dominated chirp may be improved by intentional misalignment of the laser with respect to the optical filters.

The discussion that follows evaluates the differences in filter concatenation effects on signal quality for lasers with different chirp characteristics. Directly modulated 2.5 Gbit/s (OC-48) transmitters are currently commercially available and are evaluated. Additionally, since bandwidth needs continue to increase and may drive metropolitan networks towards higher bit rate systems, OC-192 (i.e., 10 Gbit/s) directly modulated transmitters, although not readily available, are also evaluated. The performance of DMLs strongly depends on the characteristics of the laser frequency chirp. The chirp Δν(t) of a DML is related to the laser output optical power P(t) through the expression:

$$Δ v ( t ) = \frac{α}{4 π} ( \frac{ⅆ}{ⅆ t} [ ln ( P ( t ) ) ] + κ P ( t ) )$$

where α is the line width enhancement factor and κ is the adiabatic chirp coefficient. In the above equation, the first term is a structure-independent “transient” chirp and the second term is a structure-dependent “adiabatic” chirp. The first term has a significant value during relaxation oscillations. The second term is related to the relaxation oscillation damping since it is directly proportional to the gain compression factor. Laser diodes can generally be classified according to their chirp behavior into three broad categories. Two such categories are namely the adiabatic and transient chirp dominated DMLs. The third category includes the lasers that cannot be classified into the other two categories. Transient-chirp dominated laser diodes exhibit significantly more overshoot and ringing in output power and frequency deviations. The frequency difference between steady-state ones and zeros is relatively small. On the other hand, adiabatic-chirp dominated laser diodes exhibit damped oscillations and large frequency difference between steady-state ones and zeros. The transient chirp component, which is always present, is typically “masked” by the adiabatic one (i.e., the adiabatic chirp term will be larger than the transient chirp).

Many laser models exist in the literature, each having its own advantages and disadvantages. However, it is generally accepted that the rate equation based model allows laser dynamics to be evaluated with sufficient accuracy and, as such, has been adopted. Knowledge of the parameters of the model for representative simulations of the system performance is mandatory. For the purpose of the discussion herein, procedures were developed for the extraction of the rate equation parameters.

The procedures have been applied for the characterization of various DMLs from different vendors and the extracted parameters were used in the model. Two of the DMLs studied present extreme behavior. One was strongly adiabatic chirp dominated (denoted DML-1) and another was strongly transient chirp dominated (denoted DML-2).

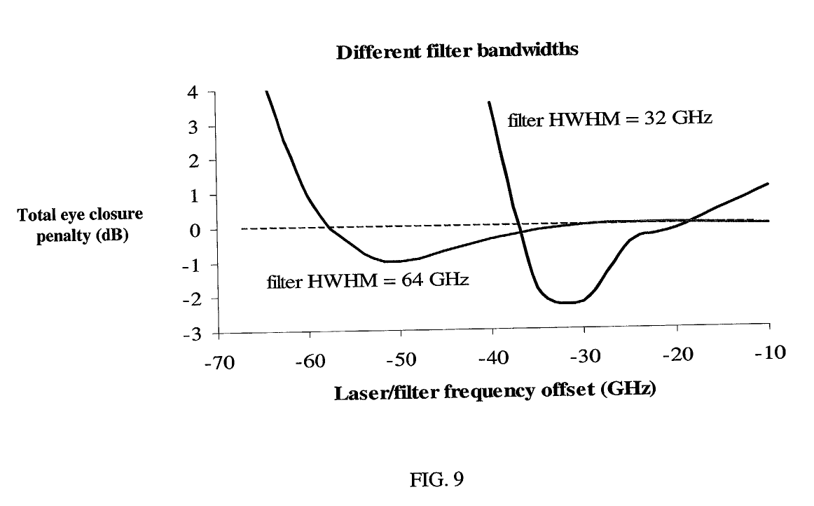

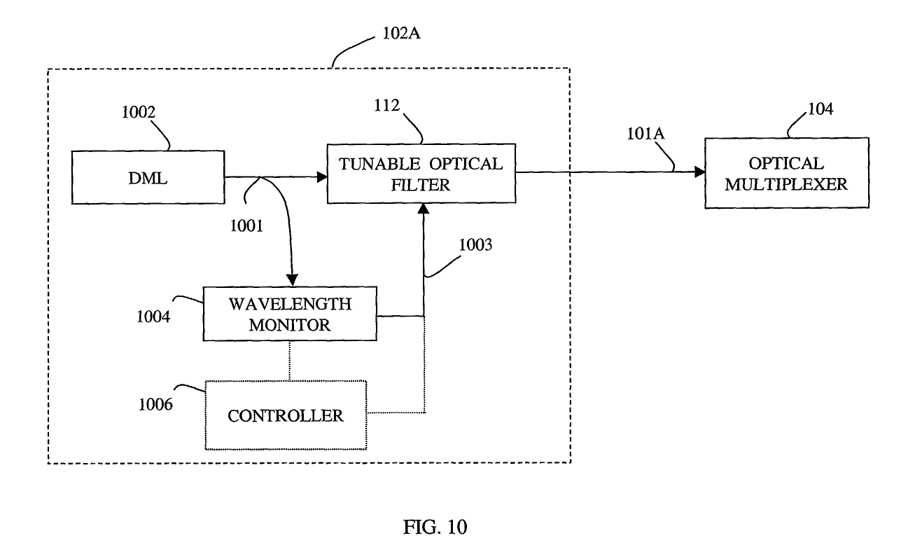

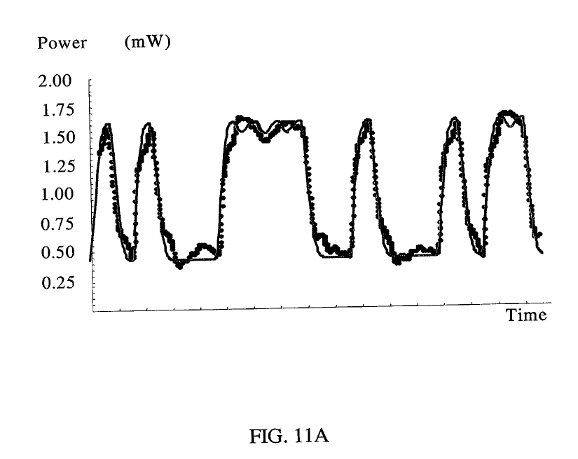

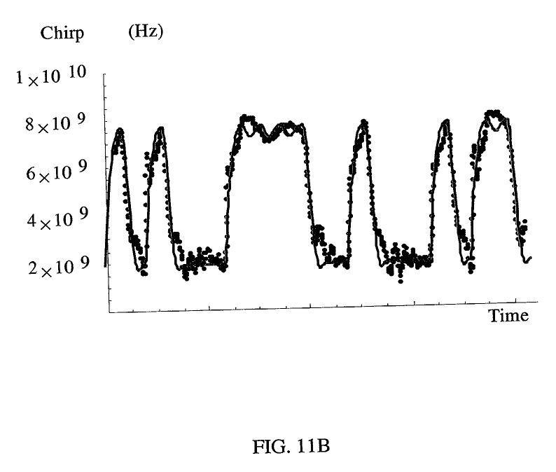

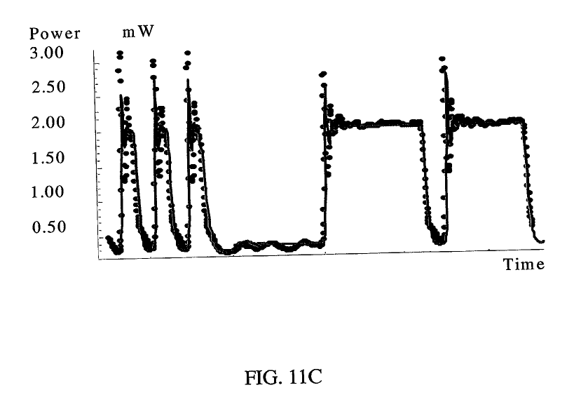

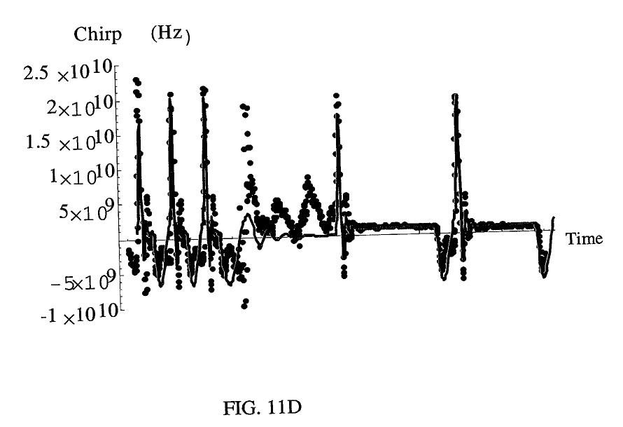

The various characteristics of the DMLs are further illustrated in FIGS. 11A-11D. As shown in FIGS. 12A and 11B, DML-1 is clearly adiabatic chirp dominated at 2.5 Gb/s as can be seen from the chirp waveform in FIG. 1B. The transient chirp has been completely masked by the adiabatic chirp component. The power waveform (FIG. 11A) shows a small power overshoot at “ones” and a small undershoot at “zeros”. A very good damping of the relaxation oscillations on the “ones” and the “zeros” is also evident. As shown in FIGS. 11C and 11D, DML-2 is clearly transient chirp dominated. The adiabatic chirp component is significantly lower than the transient chirp component. The peak-to-peak chirp is approximately 30 GHz, a value that results in a considerably broadened spectrum. The power waveform (FIG. 11C) shows a large power overshoot on the “ones” while the undershoot on the “zeros” is small. The damping of the relaxation oscillations on both the “ones” and the “zeros” is relatively slow.

The two OC-48 directly modulated lasers (DML-1, DML-2) are representative of commercially available lasers. To simulate laser responses, complex optical waveform data was generated numerically using the actual laser parameters measured for the two lasers. The conditions were adjusted to produce an optical signal with 1 mW output power and 8.2 dB extinction ratio. The optical spectra of the two OC-48 lasers simulated is shown in FIGS. 12A and 12B. The spectrum of the transient chirp dominated laser (DML-2), as shown in FIG. 12B, is much broader because of the high frequency content of the transient chirp (see FIG. 11D). However, the peak of the spectrum is centered at the nominal zero frequency, which corresponds to the peak frequency during continuous wave (CW) operation. On the other hand, the spectrum of the adiabatic chirp dominated laser (DML-1), as shown in FIG. 12A, has two distinct peaks, corresponding to the frequencies of the “ones” and the “zeros” bits. Moreover, both of these peak frequencies are shifted from the nominal CW frequency at 0 GHz. This behavior is in accordance with the chirp measurements presented in FIG. 11B. As shown, the peak frequency corresponding to the “ones” bits is shifted by approximately +8 GHz.

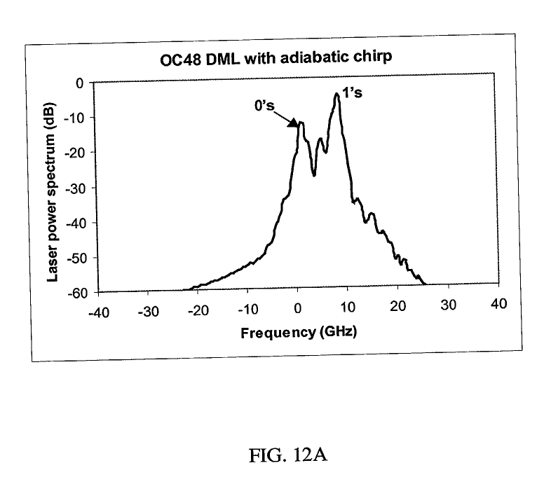

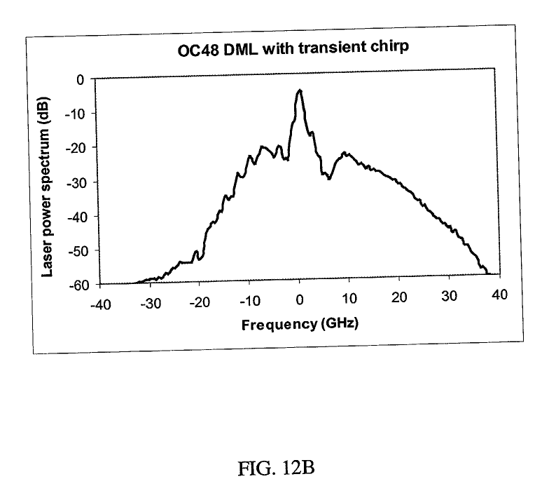

The parameters provided in an article entitled, “10-Gb/s Standard Fiber Transmission Using Directly Modulated 1.55-μm Quantum-Well DFB Lasers,” by Mohrdiek, S., Burkhard, H., Steinhagen, F., Hillmer, H., Losch, R., Schlapp, W., and Gobel, R., IEEE Photonics Technology Letters, vol. 7, p. 1357-1359, 1995, were used to generate waveforms for a 10 Gbit/s DML with adiabatic chirp behavior (OC-192/DML-1). For a second 10 Gbit/s laser (OC-192/DML-2), the material parameters of the OC-48 adiabatic chirp dominated laser were scaled to 10 Gbit/s. This produced a laser waveform with enhanced transient chirp characteristics, but did not eliminate the adiabatic chirp, which is necessary for propagation over large distances of conventional positive dispersion fiber. The comparison in this case was, therefore, between a laser with almost pure adiabatic chirp and a laser with a combination of both transient and adiabatic chirp features. The extinction ratio was about 2.75 dB for both OC-192 DMLs. These conditions were selected in order to minimize the chirp induced power penalty of transmission over standard single mode fiber. The optical spectra of the two OC-192 lasers modeled are shown in FIGS. 13A-13B. Again, it is clear that the adiabatic chirp dominated laser (OC-192/DML-1) has two peak frequencies corresponding to the “ones” and “zeros” bits. Due to the poor extinction ratio, both the “ones” and the “zeros” are shifted relative to the nominal frequency. The shift in these frequencies, from the nominal center frequency of 0 GHz, is even greater than for the OC-48 laser, and is about +9 GHz and +19 GHz for the “zeros” and “ones” bits, respectively. The laser with both transient and adiabatic chirp (OC-192/DML-2) has a smaller shift of the “ones” peak frequency of about +7 GHz. The peak frequency of the “zeros” bits is lower and is obscured by the frequency spectrum caused by the transient chirp.

For metropolitan area optical networks, the use of multilayer interference filters in the multiplexers and demultiplexers is favored because of their flat passband characteristics, low insertion loss and relatively good thermal stability. Multilayer interference filters can often be approximated by Butterworth transfer functions of various orders (ranging from second to fifth order).

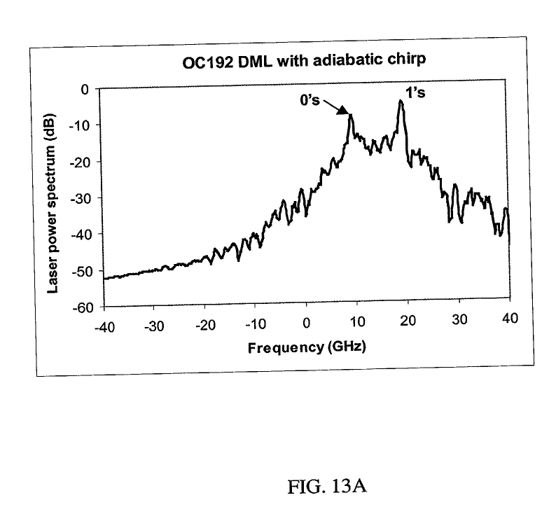

FIG. 14 illustrates the correspondence between a third-order Butterworth filter model and a real interference filter. The transmission spectrum of a third-order Butterworth filter is plotted against measured data from an actual thin film filter. The waveforms of FIG. 14 demonstrate the good fit of the Butterworth model to the filter transmittance data. The phase characteristics of multilayer interference filters can be also approximated by the Butterworth filter phase transfer function. For reference, the equation describing a complex third-order Butterworth filter is given as:

$$H ( f ) = \frac{1}{{\prod }_{k = 1}^{3} [ \frac{jf}{{f}_{3 dB}} - exp ( \frac{jπ}{2} ( 1 + \frac{2 k - 1}{3} ) ) ]}$$

where ‘j’ is equal to the sqrt(−1), ‘f’ is the frequency assumed to be centered around 0, and ‘f_{3dB}’ is the bandwidth of the filter at the −3 dB power transmission level.

The results of the simulations pertain specifically to the Butterworth filter model used and will be somewhat different for real physical filter functions. However, the filter model is representative of a significant subset of WDM filters and the results are therefore, general enough to be used in the design of metropolitan sized networks.

There are at least two effects experienced by an optical signal upon passage through multiple WDM filters in an optical network. The first is distortion induced eye closure, which is the closing of the eye diagram due to time-domain distortions, which are created by clipping or attenuation of the signal spectrum. The second effect is simple excess optical power loss caused by the filter concatenation and narrowing. This excess loss is in addition to the vendor-specified insertion loss, which is usually specified at the center of the filter passband and is a result of the increased attenuation at frequencies on either side of the center frequency. It is important to note that excess loss in the signal path can generally be addressed and corrected by increased amplification, while the distortion induced eye closure cannot be easily remedied by amplification or other techniques. The discussion herein concentrates on the eye closure impairment as the limiting factor in terms of the level of signal quality that provides acceptable system performance. This in turn dictates the maximum number of filters that can be traversed by a signal, given bounds on the laser center frequency drift. It is desirable that excess loss be included in the design of a network as it will contribute to power ripple within the WDM signals and may ultimately limit signal quality because of low optical signal-to-noise ratio (OSNR).

The distortion induced normalized ECP is the reduction in the eye opening caused by time-domain distortion, independent of total signal power loss. The eye opening for a signal is defined as follows:

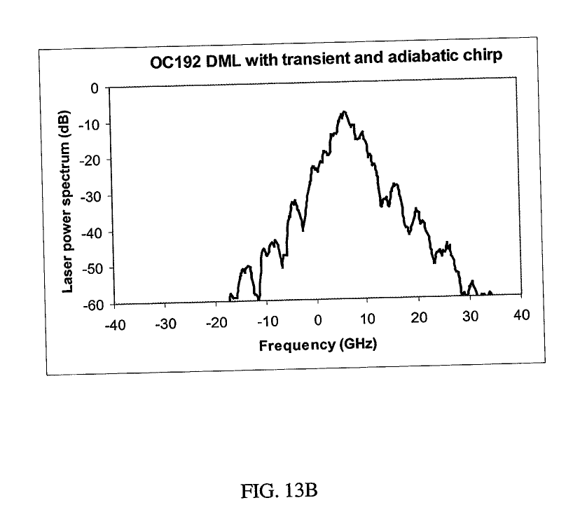

eye=I_{1,min}−I_{0,max}

where I_{1,min} and I_{0,max} are the minimum “ones” power and maximum “zeros” power, respectively, within a small time window defined around the maximum eye opening position in the eye diagram. In the simulations, two different sized time windows were used and the eye closure penalties were averaged for each to reach a penalty estimate. The first window size is an infinitely thin window that comprises only the actual time sample point where the eye opening is maximum. A slightly wider time window was used for the second case that comprises seven time sample points centered on, and including, the maximum eye opening position. Given thirty-two samples per bit period amounts to a window size of about twenty-two percent of the bit period. The purpose of using the second time window in the penalty calculations was to allow capturing the effects of signal distortions that result in sharper bit transition trajectories. An exemplary eye diagram is shown in FIG. 15.

The definition for the distortion induced normalized ECP for a signal passing through N_{f} filters with a laser center frequency offset f_{c} (in GHz) from the nominal value is:

$$normalizedECP ( dB ) = 10 log [ \frac{eye ( {N}_{f} = 0 , {f}_{c} = 0 )}{{I}_{1 , ave} ( {N}_{f} = 0 , {f}_{c} = 0 )} ] - 10 log [ \frac{eye ( {N}_{f} , {f}_{c} )}{{I}_{1 , ave} ( {N}_{f} , {f}_{c} )} ]$$

The penalty is defined with respect to the case with no filters in the signal path and no laser center frequency offset. The eye openings are normalized by the relative value of the average “ones” measured within the time window so as to eliminate the effect of excess loss incurred by passage through the filters. That is, the normalized ECP, as given in the above equation, measures only the contribution to closure of the eye that arises from signal distortion, and not simply as a result of overall attenuation (excess loss) of the signal.

A 1 dB normalized ECP budget was used as a nominal threshold for the maximum acceptable signal degradation. An actual normalized ECP budget should depend on the network design and budgets set for other signal impairments. The purpose here is to determine the effects of filter concatenation on signals in a transparent metropolitan size network and to understand the relative behavior of different DMLs with various chirp characteristics with regard to normalized ECP. To be conservative, a longest path included the traversal of twenty filters, representing a source multiplexer, receiver demultiplexer, and passage through up to nine network elements such as optical cross-connects (OXCs) or wavelength add/drop multiplexers (WADMs), in which a given signal is filtered two times. The range of laser frequency offset from the nominal filter center frequency considered was −40 GHz to +40 GHz, consistent with ITU point-to-point standards on laser frequency specifications for a 200 GHz channel spacing plan. For some filter and laser combinations, the maximum laser offset can be greater than 40 GHz from the standpoint of the normalized ECP budget. This is mainly a consequence of the choice to define the laser center frequency at the frequency during CW operation.

The filter bandwidth is chosen here to represent that channel spacing is 120 GHz at the −3 dB half-power points. A maximum filter misalignment range of ±17.5 GHz is intended to cover different sources of misalignment including fabrication and temperature changes. For all simulations, the filter misalignments were modeled as being uniformly distributed within the range specified. The uniform distribution was approximated by adding filters in groups of five, with one filter aligned at the center frequency, two filters misaligned by ±8.75 GHz, and two filters misaligned by ±17.5 GHz.

OC-48 DML with Adiabatic Chirp

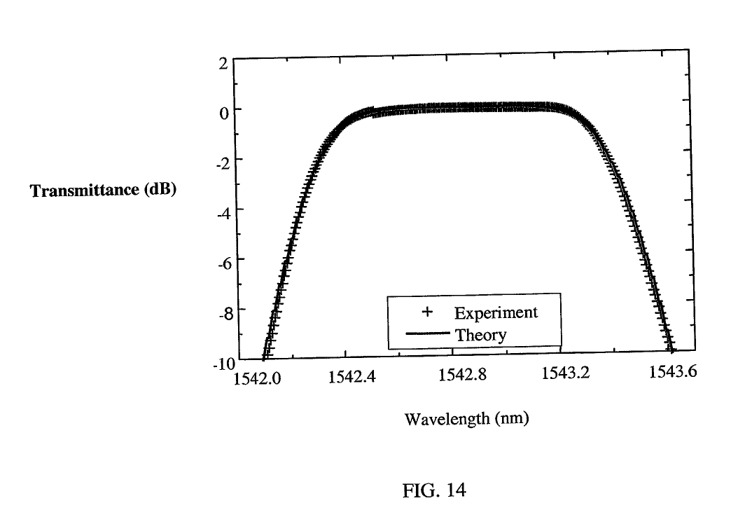

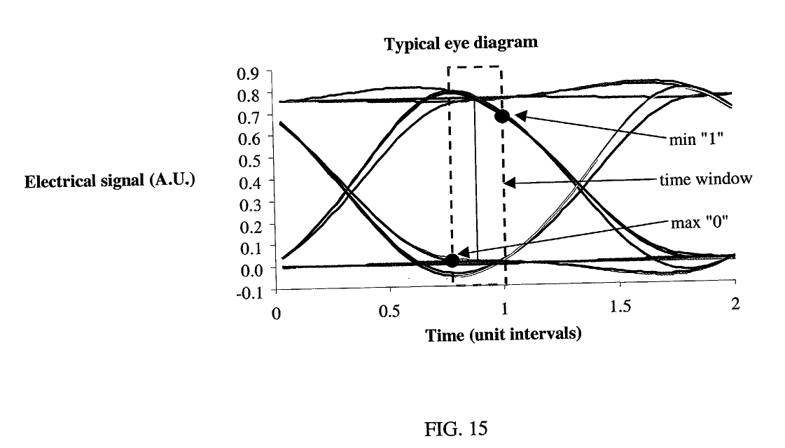

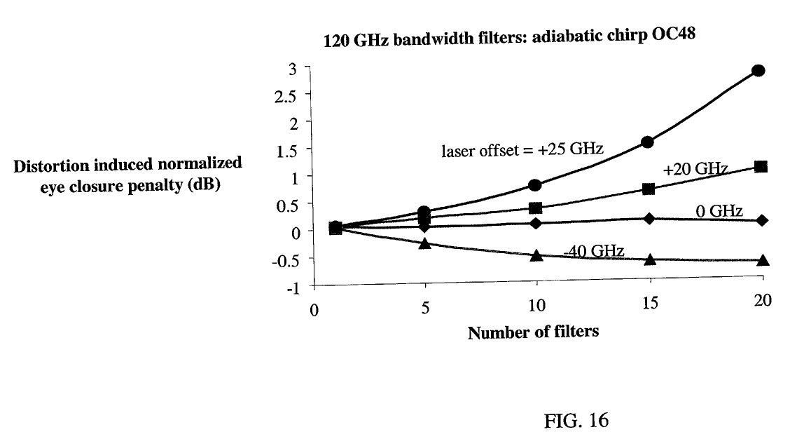

FIG. 16 provides the response curves for a OC-48 DML with adiabatic chirp characteristics for filters randomly misaligned within a ±17.5 GHz range. The different values of laser offset are meant to represent the behavior close to the boundaries of acceptable offset. Using a nominal 1 dB normalized ECP budget, the passage through at least twenty filters is possible if the laser offset is less than +20 GHz. FIGS. 17A-17B show the results for the laser in terms of the normalized ECP and the excess loss, respectively, as a function of laser offset, for passage through twenty filters. These results show a definite asymmetry with respect to the sign of the laser frequency offset, especially in terms of the distortion penalty. This is due to the two distinct peaks in the laser spectrum (see FIG. 12A) corresponding to the frequencies of the “zeros” and “ones” bits. For negative frequency detuning of the laser, the bandwidth narrowing effect filters the spectral component of the signal that corresponds to the “zeros”. This results in improvement of the extinction ratio and, therefore, the distortion-induced penalty is reduced. In fact, negative distortion penalties of almost −1 dB for laser frequency offsets with negative values can be obtained. That is, by shifting the laser center frequency by approximately −40 GHz from the nominal center frequency, the eye opening is improved with a negative penalty through twenty filters. However, one must also be aware of the excess loss, which starts to increase fairly rapidly at an offset of around −30 GHz. It is also interesting to note that in FIG. 16, the distortion penalty is still dropping at 20 filters for a −40 GHz laser offset. This implies that further signal improvement may be observed for passage through more filters, although the loss would also generally get significantly higher.

OC-48 DML with Transient Chirp

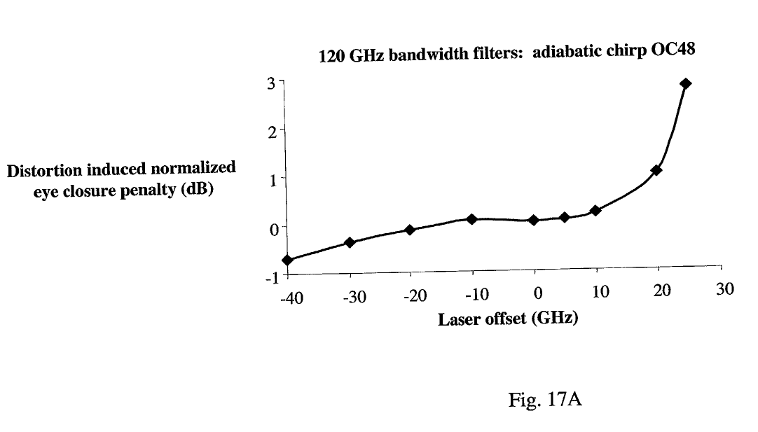

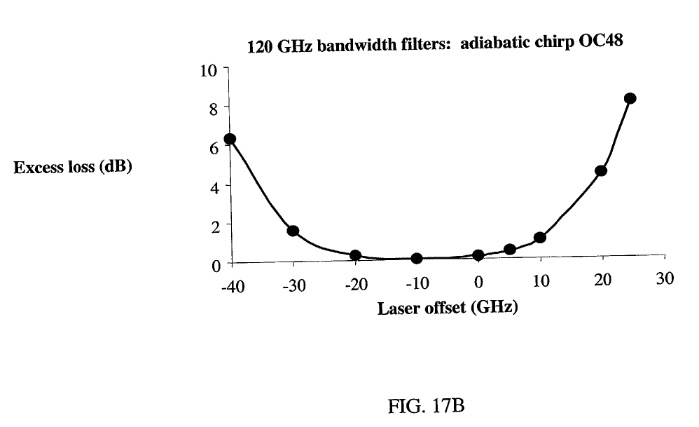

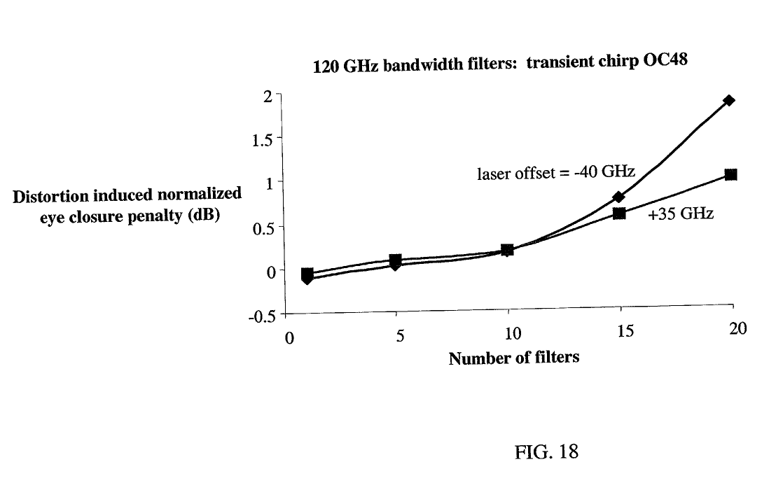

The graphical simulation results for the OC-48 DFB laser with transient chirp are shown in FIGS. 18, 19A and 19B. In this case, the behavior of both the normalized ECP and excess loss are rather symmetric with respect to laser frequency offset from the center of the filter passband. As shown in FIGS. 19A and 19B, the distortion penalty and loss increase for both positive and negative frequency detuning of the laser. The distortion induced normalized ECP requires laser frequency stability to within ±35 GHz for this simulated laser.

OC-192 DML with Adiabatic Chirp

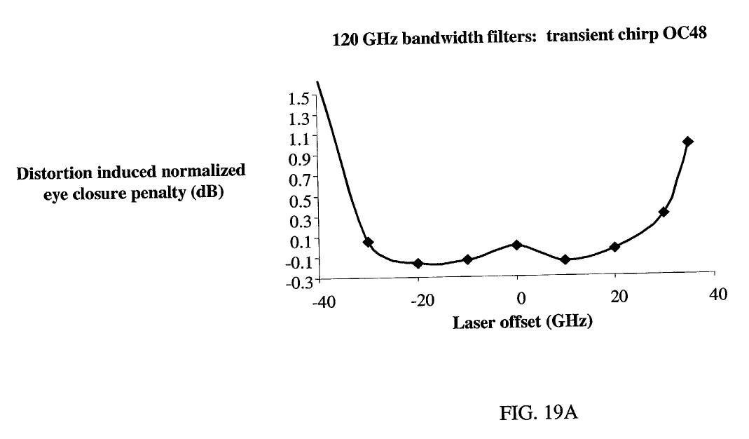

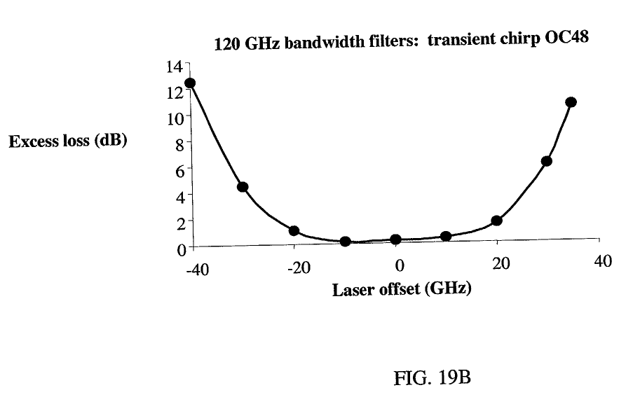

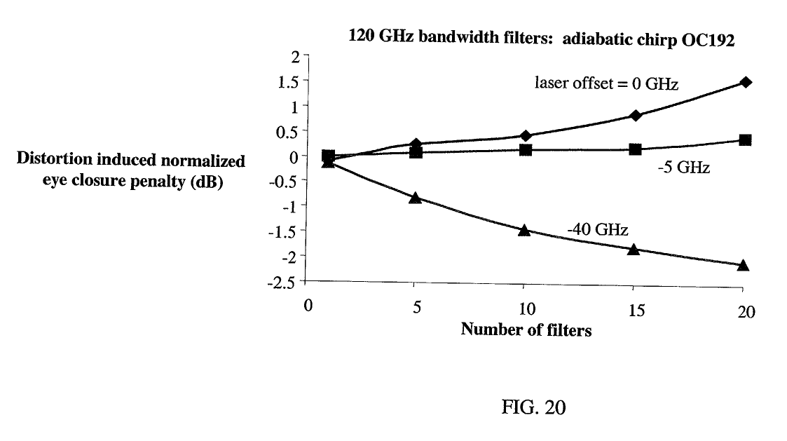

A third directly modulated laser simulated is a 10 Gbit/s laser with a large and predominantly adiabatic chirp characteristics. As discussed earlier, the DFB parameters for this laser were designed to maximize the dispersion reach, but at the expense of extinction ratio (<3 dB). The shift of the “ones” center frequency is almost +20 GHz from the CW center frequency, while the shift of the “zeros” center frequency is about +9 GHz. While this may not be a very realistic model of practical directly modulated DFB lasers, the filter concatenation simulations for it yield results that indicate some usefulness. These results are presented in FIGS. 20, 21A and 21B. In particular, shifting the laser center frequency a −40 GHz with respect to the filter center frequency, one can obtain a substantial eye opening improvement as indicated by a distortion penalty of −2 dB after passage through twenty filters. The total excess loss suffered through those twenty filters is about 1.2 dB, which can generally be easily compensated by amplifiers throughout the network. Furthermore, the position of zero laser frequency offset corresponds to the CW laser center frequency, for which the “ones” frequency is at about +20 GHz. Redefining the zero frequency position to correspond to the “ones” center frequency allows shifting in the negative direction by another 20 GHz, while remaining within the pre-defined laser frequency range limits of 40 GHz to +40 GHz. Such a further shift should open the eye still further, as suggested by the downward trend in FIG. 21A.

OC-192 DML with Transient and Adiabatic Chirp

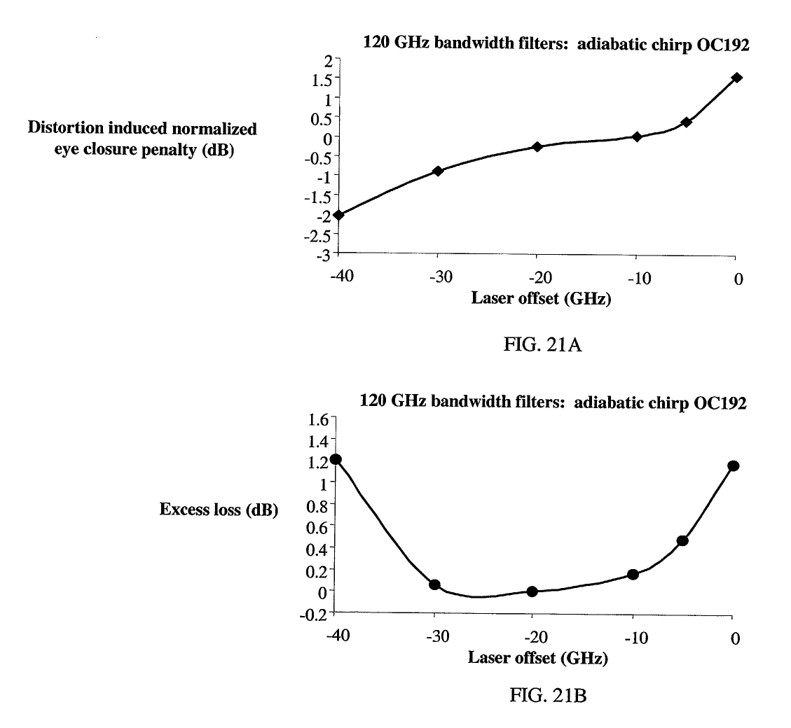

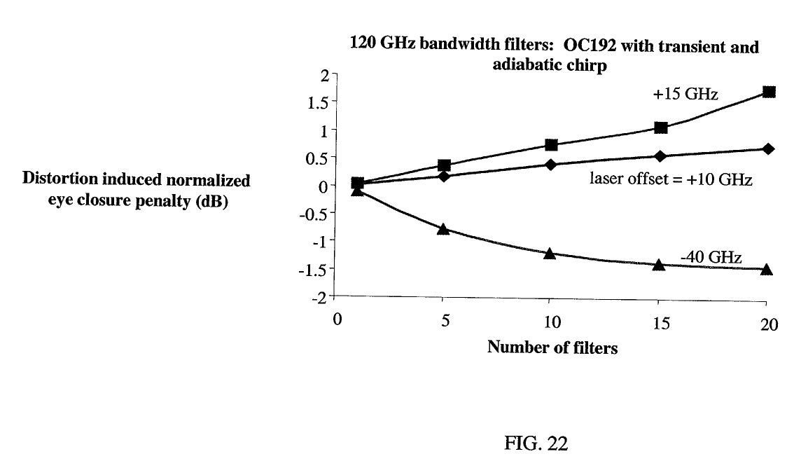

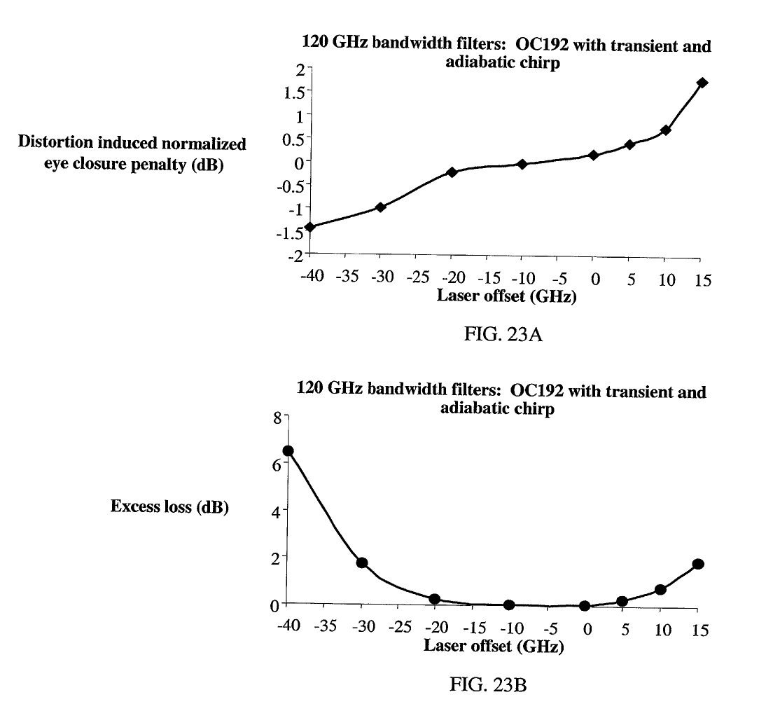

The second OC-192 DML evaluated has components of both transient and adiabatic chirp. The waveform for this laser was generated by scaling the OC-48 adiabatically chirped laser to 10 Gbit/s. The results are shown in FIGS. 22, 23A and 23B. As with the previous laser, the normalized ECP response to laser center frequency offset is very asymmetric and significant negative penalties can be induced by shifting the laser in the negative frequency offset direction. This again results in a widening of the eye by preferentially attenuating the frequencies associated with the “zeros” bits. This indicates a predominance of the adiabatic chirp component over the transient component with respect to filter concatenation effects. For this laser and set of twenty misaligned filters, the minimum penalty again occurs at a laser frequency shift of −40 GHz and it is still decreasing at that point. However, the improvement in the eye opening is smaller (−1.5 dB penalty) for this laser than for the first OC-192 laser (−2.0 dB penalty), and the excess loss of over 6 dB incurred at the −40 GHz frequency shift is significantly higher. The higher loss appears to be due to the transient chirp component, which broadens the overall spectrum.

Accordingly, an optical system has been described that implements a tunable optical filter, adjacent to or within a light receiver module or a light source module. The tunable optical filter can be used to generally improve the signal quality of an optical signal, which exhibits time-domain distortion caused by multiple optical filters. According to the present invention, the center frequency of the tunable optical filter is adjusted to maximize signal quality exhibited by the optical signal (e.g., by monitoring the bit-error rate (BER) or the Q-factor of the optical signal at the receiver). Alternatively, the relative alignment of the laser center frequency with the concatenated multiplexer and demultiplexer filters in an optical network can be optimized to increase signal quality. This applies especially to directly modulated laser transmitters with adiabatic chirp dominated characteristics and poor extinction ratios.

It will become apparent to those skilled in the art that various modifications to the preferred embodiment of the invention as described herein can be made without departing from the spirit or scope of the invention as defined by the appended claims.

The invention claimed is:

1. An optical system that maximizes signal quality related to spectral shape of an optical signal, the system comprising:
a light source module including a light source, the light source providing an optical signal to an optical fiber that includes a plurality of optical fiber segments;
a light receiver module including a receiver input that receives the optical signal from one of the plurality of the optical fiber segments;
a plurality of optical filters coupled between the light source module and the light receiver module by the plurality of optical fiber segments, wherein the plurality of optical filters filter the optical signal; and
a tunable optical filter including a control input, a filter input and a filter output, wherein the filter input receives the optical signal and the filter output provides a filtered optical signal, and wherein a center filter frequency of the tunable optical filter is varied to maximize signal quality exhibited by the filtered optical signal responsive to a control signal on the control input.

2. The system of claim 1, wherein the plurality of optical filters are fixed optical filters.

3. The system of claim 2, wherein the light source is an adiabatic chirp dominated direct modulated laser (DML).

4. The system of claim 2, wherein the plurality of fixed optical filters exhibit a transfer function substantially defined by a third-order Butterworth filter.

5. The system of claim 2, wherein the tunable optical filter is one of a tunable Fabry-Perot filter and a tunable Bragg grating filter.

6. The system of claim 2, wherein the tunable optical filter is situated within the receiver module.

7. The system of claim 2, wherein the light receiver module includes a Q-factor measurement monitor and the tunable optical filter, and wherein the Q-factor measurement monitor measures a Q-factor associated with the optical signal, and where the Q-factor measurement monitor includes a monitor input that monitors the optical signal and a monitor output that is used to provide the control signal whose value is a function of the Q-factor associated with the optical signal.

8. The system of claim 7, wherein the Q-factor measurement monitor provides a relative change in the Q-factor associated with the optical signal on the monitor output as the tunable optical filter is tuned.

9. The system of claim 7, further including:
a controller coupled to the control input of the tunable optical filter and the monitor output of the Q-factor measurement monitor, wherein the controller is programmed to vary the control signal on the control input of the tunable optical filter responsive to a signal on the monitor output.

10. The system of claim 2, wherein the light receiver module includes a bit-error rate (BER) measurement monitor and the tunable optical filter, and wherein the bit-error rate (BER) measurement monitor measures a BER associated with the optical signal, and wherein the BER measurement monitor includes a monitor input that monitors the optical signal and a monitor output that is used to provide the control signal whose value is a function of the BER associated with the optical signal.

11. The system of claim 10, wherein the BER measurement monitor provides a relative change in the BER associated with the optical signal on the monitor output as the tunable optical filter is tuned.

12. The system of claim 10, further including:
a controller coupled to the control input of the tunable optical filter and the monitor output of the BER measurement monitor, wherein the controller is programmed to vary the control signal on the control input of the tunable optical filter responsive to a signal on the monitor output.

13. The system of claim 2, wherein the light source module includes a wavelength monitor and the tunable optical filter, and wherein the wavelength monitor has a monitor input that monitors the optical signal and a monitor output that is used to provide the control signal whose value is changed responsive to variations in a center source frequency of the light source to vary the center filter frequency of the tunable optical filter to maintain a predetermined offset between the center source frequency and the center filter frequency.

14. The system of claim 13, further including:
a controller coupled to the control input of the tunable optical filter and the monitor output of the wavelength monitor, wherein the controller is programmed to vary the control signal on the control input of the tunable optical filter responsive to a signal on the monitor output.

15. The system of claim 2, wherein a center source frequency of the light source is offset from the center filter frequency of the plurality of fixed optical filters.

16. The system of claim 2, wherein the spectral distortion of the optical signal is attributable to clipping of the optical signal by at least one of the fixed optical filters.

17. The system of claim 2, wherein the spectral distortion of the optical signal is attributable to laser chirping associated with the light source module.

18. An optical system that maximizes signal quality related to spectral shape of an optical signal, the system comprising:
a light source module including a light source, the light source providing an optical signal to an optical fiber that includes a plurality of optical fiber segments;
a light receiver module including a receiver input that receives the optical signal from one of the plurality of the optical fiber segments; and
a plurality of fixed optical filters coupled between the light source module and the light receiver module by the plurality of optical fiber segments, wherein the plurality of fixed optical filters filter the optical signal and a center filter frequency of at least one of the fixed optical filters is not aligned with a center source frequency of the light source, and wherein the center source frequency is varied to maximize signal quality exhibited by the optical signal.

19. The system of claim 18, wherein the light source is an adiabatic chirp dominated direct modulated laser (DML).

20. The system of claim 18, wherein the plurality of fixed optical filters exhibit a transfer function substantially defined by a third-order Butterworth filter.

21. A light receiver module that maximizes signal quality related to spectral shape of an optical signal provided by a light source, the module comprising:
a light receiver having a receiver input;
a tunable optical filter including a control input, a filter input and a filter output, wherein the filter input is coupled to the light source and the filter output is coupled to the receiver input, and wherein a center filter frequency of the tunable optical filter is varied to maximize signal quality exhibited by the optical signal responsive to a control signal on the control input.

22. The module of claim 21, wherein the optical filter is one of a tunable Fabry-Perot filter and a tunable Bragg grating filter.

23. The module of claim 21, wherein the light source is an adiabatic chirp dominated direct modulated laser (DML).

24. The module of claim 21, wherein the light receiver module includes a Q-factor measurement monitor and the tunable optical filter, and wherein the Q-factor measurement monitor measures a Q-factor associated with the optical signal, and wherein the Q-factor measurement monitor includes a monitor input that monitors the optical signal and a monitor output that is used to provide the control signal whose value is a function of the Q-factor associated with the optical signal.

25. The module of claim 24, wherein the Q-factor measurement monitor provides a relative change in the Q-factor associated with the optical signal on the monitor output as the tunable optical filter is tuned.

26. The module of claim 24, further including:
a controller coupled to the control input of the tunable optical filter and the monitor output of the Q-factor measurement monitor, wherein the controller is programmed to vary the control signal on the control input of the tunable optical filter responsive to a signal on the monitor output.

27. The module of claim 21, wherein the light receiver module includes a bit-error rate (BER) measurement monitor and the tunable optical filter, and wherein the bit-error rate (BER) measurement monitor measures a BER associated with the optical signal, and wherein the BER measurement monitor includes a monitor input that monitors the optical signal and a monitor output that is used to provide the control signal whose value is a function of the BER associated with the optical signal.

28. The module of claim 27, wherein the BER measurement monitor provides a relative change in the BER associated with the optical signal on the monitor output as the tunable optical filter is tuned.

29. The module of claim 27, further including:
a controller coupled to the control input of the tunable optical filter and the monitor output of the BER measurement monitor, wherein the controller is programmed to vary the control signal on the control input of the tunable optical filter responsive to a signal on the monitor output.

30. A light source module that maximizes signal quality related to spectral shape of an optical signal provided by a light source, the module comprising:
a light source for providing an optical signal at a center source frequency; and
a tunable optical filter including a control input, a filter input and a filter output, wherein the filter input receives the optical signal and the filter output provides a filtered optical signal, and wherein a center filter frequency of the tunable optical filter is varied to maximize signal quality exhibited by the filtered optical signal responsive to a control signal on the control input.

31. The module of claim 30, wherein the optical filter is one of a tunable Fabry-Perot filter and a tunable Bragg grating filter.

32. The module of claim 30, wherein the light source is an adiabatic chirp dominated direct modulated laser (DML).

33. The module of claim 30, wherein the light source module also includes a wavelength monitor, and wherein the wavelength monitor has a monitor input that monitors the optical signal and a monitor output that is used to provide the control signal whose value is changed responsive to variations in a center source frequency of the light source to vary the center filter frequency of the tunable optical filter to maintain a predetermined offset between the center source frequency and the center filter frequency.

34. The module of claim 30, further including:
a controller coupled to the control input of the tunable optical filter and the monitor output of the wavelength monitor, wherein the controller is programmed to vary the control signal on the control input of the tunable optical filter responsive to a signal on the monitor output.

35. A method for maximizing signal quality of an optical signal in an optical system, the method comprising the steps of:
providing a light source module including a light source, the light source providing an optical signal to an optical fiber that includes a plurality of optical fiber segments;
providing a light receiver module including a receiver input that receives the optical signal from one of the plurality of the optical fiber segments;
providing a plurality of fixed optical filters coupled between the light source module and the light receiver module by the plurality of optical fiber segments, wherein the plurality of fixed optical filters filter the optical signal; and
providing a tunable optical filter including a control input, a filter input and a filter output, wherein the filter input receives the optical signal and the filter output provides a filtered optical signal, and wherein a center filter frequency of the tunable optical filter is varied to maximize signal quality exhibited by the filtered optical signal responsive to a control signal on the control input.

36. The method of claim 35, wherein the light source is an adiabatic chirp dominated direct modulated laser (DML).

37. The method of claim 35, wherein the plurality of fixed optical filters exhibit a transfer function substantially defined by a third-order Butterworth filter.

38. A method for maximizing signal quality of an optical signal in an optical system, the method comprising the steps of:
providing a light source module including a light source, the light source providing an optical signal to an optical fiber that includes a plurality of optical fiber segments;
providing a light receiver module including a receiver input that receives the optical signal from one of the plurality of the optical fiber segments; and
providing a plurality of fixed optical filters coupled between the light source module and the light receiver module by the plurality of optical fiber segments, wherein the plurality of fixed optical filters filter the optical signal and a center filter frequency of at least one of the fixed optical filters is not aligned with a center source frequency of the light source, and wherein the center source frequency is varied to maximize signal quality exhibited by the optical signal.

39. The method of claim 38, wherein the light source is an adiabatic chirp dominated direct modulated laser (DML).

40. The method of claim 38, wherein the plurality of fixed optical filters exhibit a transfer function substantially defined by a third-order Butterworth filter.
